(19) United States
(12) Patent Application Publication
(10) Pub. No.: US 2012/0120596 A1
(43) Pub. Date: May 17, 2012

(54) Air cooling architecture for network switch chassis with orthogonal midplane

(75) Inventor: Andreas Bechtolsheim, Menlo Park, CA (US)

(73) Assignee: Arista Networks, Inc.

(21) Appl. No.: 13/373,489

(22) Filed: Nov. 16, 2011

Related U.S. Application Data
(60) Provisional application No. 61/414,390, filed on Nov. 16, 2010.

(51) Int. Cl. G06F 1/20

(52) U.S. Cl. 361/679.48

(57) ABSTRACT

A network switch chassis provides a linear, front-to-rear air flow path for cooling first and second orthogonally oriented arrays of parallel circuit boards connected by a midplane. Air is drawn into the front of the chassis and passes in a straight path over the first array of circuit boards, through air openings in the midplane, over the second array of circuit boards, and out the rear of the chassis. Resilience against service interruption due to fan failure is achieved with multiple fans cooling each circuit board.

### CROSS-REFERENCE TO RELATED APPLICATIONS

This application claims priority from U.S. Provisional Patent Application 61/414390 filed Nov. 16, 2010, which is incorporated herein by reference.

### FIELD OF THE INVENTION

The present invention relates generally to the design of network switches. More specifically, it relates to techniques for resilient cooling in a network switch chassis with an orthogonal midplane design.

### BACKGROUND OF THE INVENTION

Networking switches are commonly built with multiple circuit boards that plug into a common backplane that provides connectors and traces for establishing electrical connections between the different types of circuit boards that plug into the backplane. This type of chassis is also commonly called a modular network switching chassis. Numerous electronic components are attached to each circuit board that consume power and therefore generate heat and need to be cooled. The circuit boards and the backplane are generally housed in a chassis enclosure that also houses the power supplies and air movers such as fans or blowers for cooling the circuit boards. The chassis typically also provides card guides that form channels within which the circuit boards can slide to ensure they are inserted with the right alignment into the backplane connectors.

A conventional networking chassis typically includes line cards, which contain circuits and the external interface connectors, and fabric cards, which contain switching circuits for connecting line cards. To achieve the highest degree of connectivity between line cards and fabric cards; high-performance network switches use an orthogonal mid-plane design where the line cards are oriented in one direction (either horizontal or vertically) and are inserted into the mid-plane from the front of the chassis, while the fabric cards are oriented in a direction orthogonal to the line cards and are inserted into the mid-plane from the rear of the chassis.

A chassis with an orthogonal mid-plane creates a cooling challenge since the orientation of the two sets of circuit boards are orthogonal to each other. Existing orthogonal chassis designs typically use multiple airflow paths to cool each set of cards. For example, the Cisco Nexus 7018 chassis has horizontal line cards that are air cooled side-to-side, and has vertical fabric cards that are cooled using separate blowers. However, side-to-side chassis airflow is not desirable for data centers that use cold-aisle/hot-aisle layout, which require airflow to go from the cold aisle to the hot aisle. The common way to accommodate side-to-side airflow network chassis in cold-aisle/hot-aisle data centers is to enclose them in an oversize rack that provides the front-to-side and side-to-rear cooling channels. This type of rack requires a larger foot-print than a standard server rack and wastes valuable real estate in the data center.

Other networking switches such as the Cisco Nexus 7010 use vertical line cards with airflow that enters on the bottom of the chassis, takes a 90 degree vertical turn across the line cards and then takes another 90 degree turn to exit to the rear of the chassis, with a secondary air flow path for the fabric cards. This type of chassis design achieves the front-to-back airflow that is compatible with datacenter cold/hot aisle layout. However, because of the two 90 degree airflow turns, this type of chassis design wastes a large amount of space for the airflow to enter and exit the chassis. In addition, turning the airflow direction wastes cooling energy. For all these reasons, the front-to-rear cooling approach that takes two 90 degree turns through the chassis is not satisfactory.

One of the least reliable elements in a networking switch are the fans which move the air through the chassis to cool the active components that generate heat. A typical fan has an L10 life of 40,000 hours, meaning after 4.0,000 hours 10% of the fans are expected to fail due to wear-out and other failure modes. However, a typical modular networking chassis has many fans, and a data center typically has many networking switches. Thus, the aggregate failure rates of all the fans in all the network switches within a data center can be quite high. If such fan failures were to interrupt the throughput of the network, it would have a severe impact on the overall data center availability and the applications the data center provides.

### SUMMARY OF THE INVENTION

The present invention provides an improved technique for air cooling orthogonal arrays of circuit boards in network switches, while providing a compact design, redundant airflow and the ability to hot-swap line cards, fabric cards, cooling fans, power supplies and other system components without interrupting the network switch operation.

In one aspect, the invention provides a network switch chassis having a first array of parallel circuit boards plugged into a front surface of the chassis, a second array of parallel circuit boards plugged into a rear surface of the chassis, a midplane located inside the chassis between the first array of parallel circuit boards and the second array of parallel circuit boards, front surface air flow openings in the front surface of the chassis, and fan modules positioned at the rear surface of the chassis.

The two arrays of parallel circuit boards are oriented orthogonal to each other. Specifically, the first array of parallel circuit boards are hot-swappable line cards having a first orientation. The second array of parallel circuit boards are hot-swappable fabric cards having a second orientation orthogonal to the first orientation.

The midplane has midplane air flow openings between orthogonal connectors that provide electrical connections between the first array of parallel circuit boards and the second array of parallel circuit boards. As a result of the midplane air flow openings together with the orthogonal arrangement of the first array of parallel circuit boards with respect to the second array of circuit boards, the fan modules produce a linear airflow path straight through the chassis between the front surface and the rear surface.

In some embodiments, the multiple fan modules are hot-swappable and can be configured to selectively produce either a front-to-rear linear airflow path straight through the chassis or a rear-to-front airflow path straight through the chassis. The network switch chassis preferably includes reverse flow air blockers associated with each of the fan modules, whereby air is prevented from flowing into the chassis through a failed fan module.

In some embodiments, each of the fabric cards is attached to a fan module having multiple fans, and each of the line cards has multiple networking ports. Each of the midplane air openings may be positioned next to one of the orthogonal connectors. The network switch chassis may include dual management controllers in the front of the chassis, as well as power supply modules in the rear of the chassis, in which case the orthogonal connectors also provide connections for the power supply modules.

### BRIEF DESCRIPTION OF THE DRAWING FIGURES

FIGS. 1A-C show a front isometric view of a network switch chassis according to a preferred embodiment of the invention.

FIGS. 2A-C show a rear isometric view of a network switch chassis according to a preferred embodiment of the invention.

FIGS. 3A-C show rear, side, and front views, respectively, of a midplane of a network switch chassis according to a preferred embodiment of the invention.

### DETAILED DESCRIPTION OF THE PREFERRED EMBODIMENT

As used throughout this document, words such as “comprise”, “including” and “having” are intended to set forth certain items, steps, elements or aspects of something in an open-ended fashion. Unless a specific statement is made to the contrary, these words do not indicate a closed-end list to which additional things cannot be added.

In general, the designations “front”, “rear”, “left” and “right” are used here-in to designate relative positions. These designations should not be construed as absolute positions.

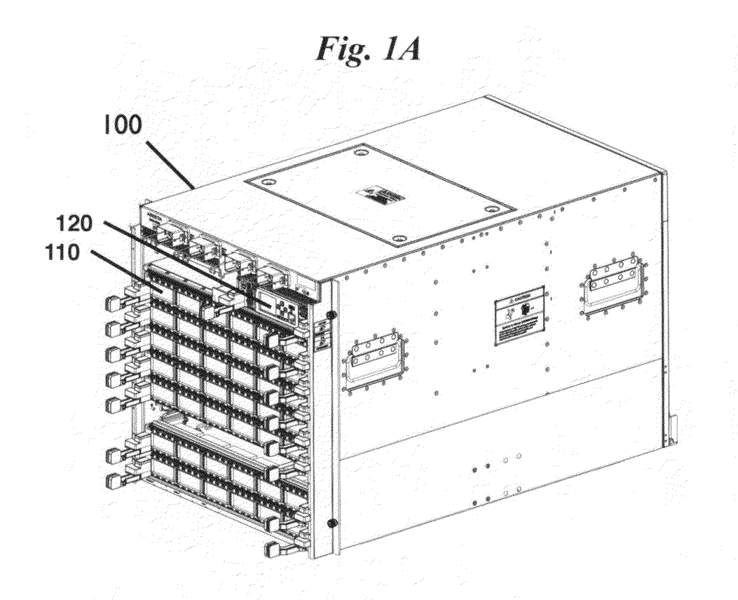

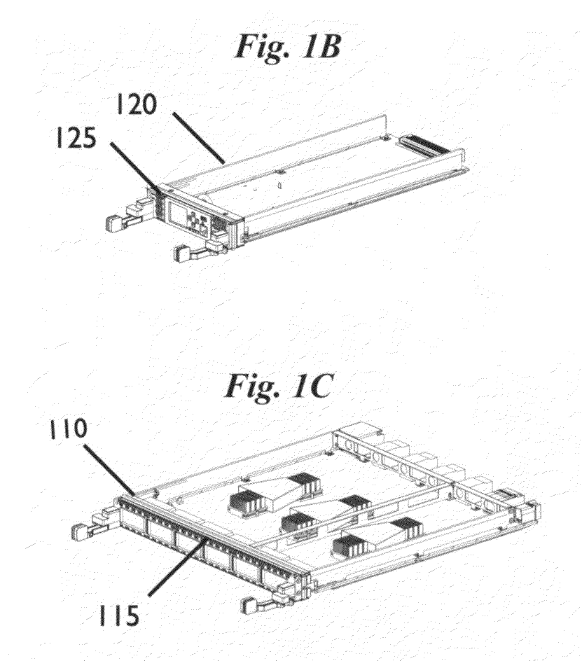

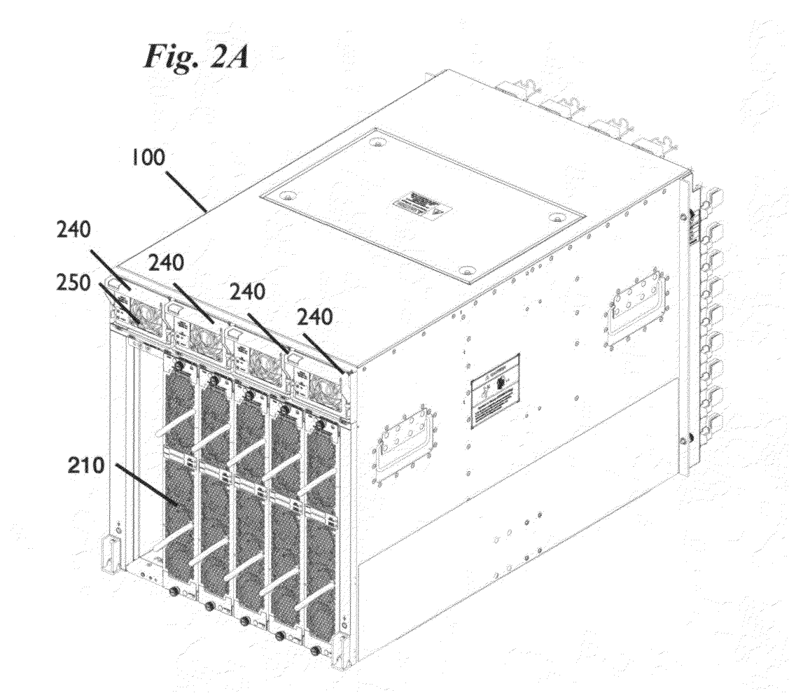

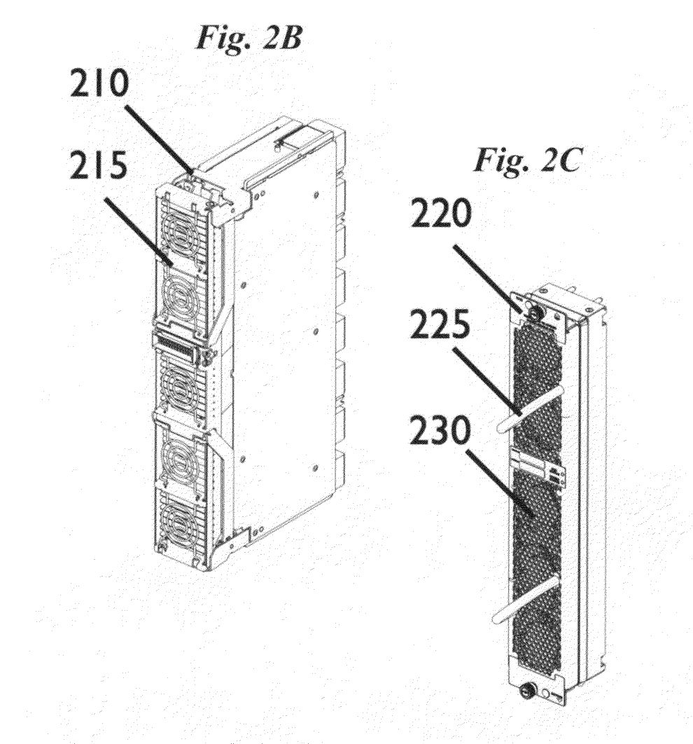

FIGS. 1A-C and 2A-C show the front and the rear views, respectively, of a network chassis 100 configured in accordance with an embodiment of the invention. As shown in FIG. 1A, the network chassis 1.00 includes a first array of parallel circuit boards 110 (FIG. 1C) plugged into a front surface of chassis 100 and, as shown in FIG. 2A, the network chassis includes a second array of parallel circuit boards 210 (FIG. 2B) plugged into the rear surface of the chassis.

In addition to the above elements, FIG. 1A shows dual management controllers 120 (FIG. 1B) in the front of chassis 100 and FIG. 2A shows four power supply modules 240 in the rear of the chassis 200.

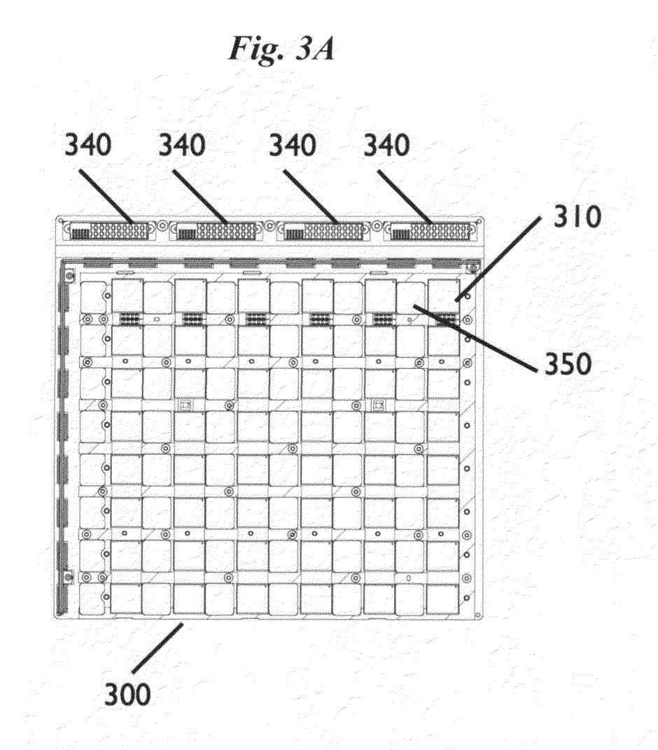

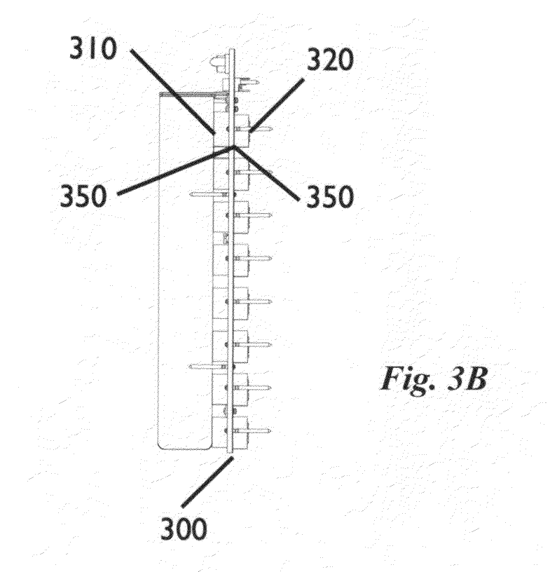

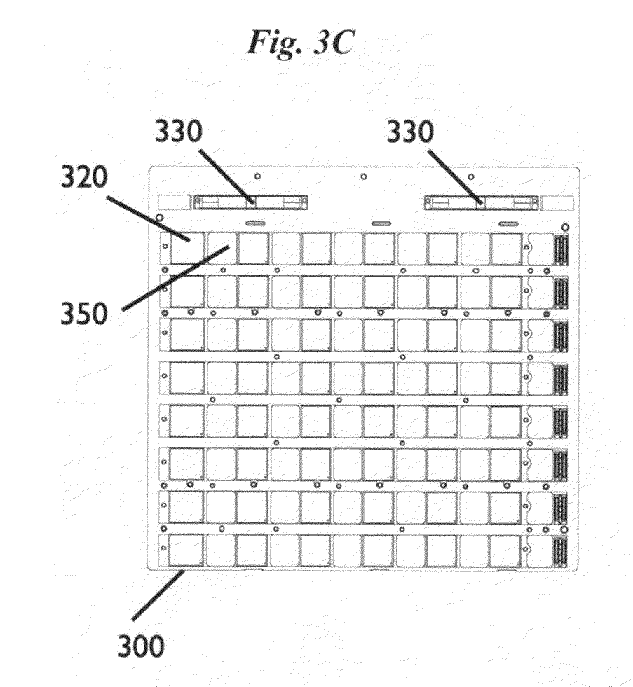

As shown in FIG. 1A, the circuit boards 110 represent line cards oriented horizontally, and as shown in FIG. 2A, the circuit board 210 represent fabric cards that are oriented vertically. Preferably, each circuit card 110 extends across the width of the array of circuit boards 210 and vice versa. Connections between circuit board 110 and circuit board 210 are preferably made straight through the mid-plane 300, shown in FIGS. 3A-C.

The mid-plane 300 is located inside the Chassis 100 and interconnects the various circuit boards and other components that are inserted from the front and the rear. Mid-plane 300 uses orthogonal connectors 310 and 320 to provide the connections between circuit boards 110 and circuit boards 210, respectively. In addition, the mid-plane includes air openings 350 to allow airflow to pass between the front and the rear. In the preferred implementation, there is one air opening 350 next to each orthogonal connector 310 and 320. Finally mid-plane connectors 330 provide the connections for the management controllers 130 and connectors 340 for the power supply modules 240.

The network chassis 100 includes a single air cooling path for cooling circuit boards 110 and circuit boards 210 that travels in a substantially linear fashion through the chassis. The air cooling path passes through perforated openings 115 in the bezel or circuit cards 110, across the circuit card 110, through air flow openings 350 in the mid-plane 300, through the circuit card 210, through the reverse airflow blocker 215, and through the fan module 220, with the air exiting through the perforated openings 225.

In case a fan 230 fails, the reverse flow air blocker 215 located next to the failed fan will close to prevent reverse air-flow that would pull hot air from the rear into the chassis. Because there are multiple fans 230 with multiple air blockers 215 for each individual circuit card 210, a single fan failure will not create a service interruption.

In case an entire fan module 220 fails, the air flow through that specific fan module is interrupted; however, this will not interrupt the air flow for the rest of the chassis 100. While the failure of a fan module 220 will prevent air flow across the circuit board 210 associated with the failed fan module, the remaining operating fan modules 220 that are associated with other circuit cards 210 will cool all the circuit boards 110 due to the orthogonal orientation of the fan modules 220 with respect to the circuit boards 110.

In one embodiment, the circuit cards 210 provide extra switching capacity for the circuit cards 110, such that full network switch throughput is achieved even if one of the circuit cards 210 has failed or is disabled due to fan module failure. With this embodiment, a failure of a fan module 220 will not affect the overall throughput of the network switch.

Other elements to achieve high resiliency are dual management controllers 120 and multiple power supply modules 240 to allow for redundant system operation in case of power supply module or management processor failure.

The network chassis 100 provides a separate cooling path for the dual management controllers 120. Airflow is provided front-to-back through the perforated air openings 125 in the bezel of the management controller 120, traveling straight through the chassis above mid-plane 300 which is designed to be less than full chassis height, and exiting through the fans 250 in the power supply modules 240. This separate cooling path for the management controllers and the power supply is isolated and separate from the air cooling path for circuit boards 110 and 210.

Having described certain embodiments above, numerous alternative embodiments or variations can be made. For example, as shown and described, a mid-plane 300 is used to interconnect circuit boards 110 and 210. This is not required, however. In an alternate embodiment, the mid-plane 300 can be omitted and the orthogonal connectors from the circuit board 110 and circuit board 210 can directly mate to each other.

As shown and described, the fan module 220 includes five individual fans 230, however this is not required. More or less fans can be used. Also the chassis of FIG. 2A uses four power supply modules 240. However, this is not required. More or fewer power supply modules can be used.

As seen on FIG. 2C, the fan modules 220 preferably have the same size and shape as the circuit boards 210 shown in FIG. 2B. The fan module 220 preferably is a separate assembly that plugs into circuit board 210 and can be removed separately for servicing. This is not required, however. In an alternative embodiment, the fans 230 can be made part of circuit board 210 in which case circuit board 210 would be removed for servicing the fans. In a preferred embodiment, the line cards, fabric cards, cooling fans, power supplies are all hot-swappable, i.e., can be removed and/or replaced for servicing while the switch is operating, without interfering with the operation of other components of the switch.

In one embodiment of the invention, air flows from the front air openings 115 straight through chassis 100 and exits through rear air openings 225 on the rear of chassis 100. Significantly, due to the arrangement of modules and the openings in the midplane, the airflow follows a linear path straight through the chassis, i.e., the airflow is not diverted and does not change direction within the chassis as it flows from front to rear. In another embodiment of the invention, the air flow is reversed and flows from the rear air openings 225 through the chassis 100 and exits at the front air openings 115. This reversal can be implemented by replacing the fan modules or by reversing the operation of existing fan modules. In this case, the airflow also follows a straight, linear path through the chassis, but in the opposite direction from rear to front.

1. A network switch chassis comprising:
a first array of parallel circuit boards plugged into a front surface of the chassis, wherein the first array of parallel circuit boards are line cards having a first orientation, wherein each of the line cards is hot-swappable;
a second array of parallel circuit boards plugged into a rear surface of the chassis, wherein the second array of parallel circuit boards are fabric cards having a second orientation orthogonal to the first orientation, wherein each of the fabric cards is hot-swappable;
a midplane located inside the chassis between the first array of parallel circuit boards and the second array of parallel circuit boards, wherein the midplane comprises midplane air flow openings and orthogonal connectors, wherein the orthogonal connectors provide electrical connections between the first array of parallel circuit boards and the second array of parallel circuit boards;
front surface air flow openings in the front surface of the chassis; and
fan modules positioned at the rear surface of the chassis;
wherein, as a result of the midplane air flow openings together with the orthogonal arrangement of the first array of parallel circuit boards with respect to the second array of circuit boards, the fan modules produce a linear airflow path straight through the chassis between the front surface and the rear surface.

2. The network switch chassis of claim 1 wherein the multiple fan modules can be configured to selectively produce either a front-to-rear linear airflow path straight through the chassis or a rear-to-front airflow path straight through the chassis.

3. The network switch chassis of claim 1 wherein the fan modules are hot-swappable.

4. The network switch chassis of claim 1 wherein each of the line cards has multiple networking ports.

5. The network switch chassis of claim 1 wherein each of the fabric cards is attached to a fan module comprising multiple fans.

6. The network switch chassis of claim 1 further comprising reverse flow air blockers associated with each of the fan modules, whereby air is prevented from flowing into the chassis through a failed fan module.

7. The network switch chassis of claim 1 wherein each of the air openings is positioned next to one of the orthogonal connectors.

8. The network switch chassis of claim 1 further comprising dual management controllers in the front of the chassis.

9. The network switch chassis of claim 1 further comprising power supply modules in the rear of the chassis.

10. The network switch chassis of claim 9 wherein the orthogonal connectors provide connections for the power supply modules.
